(19) United States
(12) Patent Application Publication
(10) Pub. No.: US 2008/0211986 A1
(43) Pub. Date: Sep. 4, 2008

(54) LAMP SOCKET, BACKLIGHT ASSEMBLY EQUIPPED WITH THE SAME, AND LIQUID CRYSTAL DISPLAY EQUIPPED WITH THE BACKLIGHT ASSEMBLY

(76) Inventors: Hyun Chul Bae, Cheonan-Si (KR); Jin Ho Ha, Suwon-Si (KR); Jin Hee Park, Cheonan-Si (KR)

Correspondence Address: MACPHERSON KWOK CHEN & HEID LLP, 2033 GATEWAY PLACE, SUITE 400, SAN JOSE, CA, 95110, US

(21) Appl. No.: 11/968,545

(22) Filed: Jan. 2, 2008

(30) Foreign Application Priority Data
Jan. 3, 2007 (KR) 10-2007-0000627
Jan. 8, 2007 (KR) 10-2007-0002104

(51) Int. Cl. G02F 1/1333; H01R 13/66; F21V 21/00

(52) U.S. Cl. 349/60; 439/620.02; 362/240

(57) ABSTRACT

A liquid crystal display equipped with a backlight assembly having a lamp socket comprising, a lamp lead seating portion on which a lamp lead is seated, and a contact terminal fastened to the lamp lead seating portion to fix the lamp lead.

### CROSS REFERENCE TO RELATED APPLICATION

This application claims priority from Korean Patent Application No. 10-2007-0000627 filed on Jan. 3, 2007 and Korean Patent Application No. 10-2007-0002104 on Jan. 8, 2007 in the Korean Intellectual Property Office, the disclosures of which are incorporated herein by reference in their entirety.

### BACKGROUND OF THE INVENTION

1. Field of the Invention

The present invention relates to a liquid crystal display having a back light unit equipped with the lamp socket and, more particularly, to a lamp socket using a chassis.

2. Description of the Related Art

Liquid crystal display devices display desired images through a liquid crystal display panel by controlling the amount of light passing therethrough in response to image signals applied to a plurality of control switches arranged in a matrix form. Such a liquid crystal display needs a light source such as a backlight because it cannot emit light by itself. For example, a cold cathode fluorescent lamp is generally used as a light source. However, in order to fix the lamp and supply power to the lamp, a large number of components are needed, and material cost and manufacturing time are increased, which consequently increases the manufacturing cost of backlight assemblies and liquid crystal displays.

### SUMMARY OF THE INVENTION

According to an exemplary embodiment of the invention, a lamp socket is provided including: a lamp lead seating portion to seat a lamp lead; and a contact terminal fastened to the lamp lead seating portion for fixing the lamp lead seated in the lamp lead seating portion.

The lamp lead seating portion includes a blade and a seating groove formed in the blade. And the contact terminal includes a spring tab placed on the lamp lead seating portion and a gantry extended from the spring tab for pressing the lamp lead.

The lamp socket further includes a housing having a body provided with a receiving space covering the lamp lead seating portion and the contact terminal.

The lamp socket further includes a first fastening portion to fasten the lamp lead seating portion to the housing.

The lamp socket further includes a second fastening portion to fasten the contact terminal to the housing.

The first fastening portion includes: fastening ears formed at the blade of the lamp lead seating portion; and first fastening slots or stops formed at the body of the housing to fit the fastening ears.

The second fastening portion includes: second fastening protrusions formed at the spring tab of contact terminal; and second fastening holes formed at the body of the housing to fit the second fastening protrusions.

The lamp socket further includes a third fastening portion fastening the contact terminal to the lamp lead seating portion.

The third fastening portion includes: fastening ears formed at the blade of the lamp lead seating portion; and third fastening holes formed at the contact terminal.

The blade of the lamp lead seating portion is formed in a plate shape and the seating groove is formed by extending from a side of the blade in a first direction.

The seating groove includes: a first seating groove extending from a first side of the blade in a first direction; and a second seating groove extending from the first seating groove in a second direction.

The gantry of the contact terminal includes: a first pressing portion extended from an end of the spring tab and bent to be connected to the other end of the spring tab; and a second pressing portion formed in a shape corresponding to the first pressing portion and spaced apart by a predetermined distance from the first pressing portion.

The gantry further includes a third pressing portion connecting the first pressing portion with the second pressing portion, at a position corresponding to the seating groove.

The gantry of the contact terminal is formed by extending from a side of the spring tab, at a position corresponding to the seating groove.

According to an exemplary embodiment of the invention, a backlight assembly is provided including: a chassis provided with a receiving space; lamps including a lamp tube and lamp leads provided at both ends of the lamp tube, respectively; and lamp sockets disposed inside the chassis to fix and apply power to the lamps, wherein the lamp socket includes a lamp lead seating portion to seat the lamp lead thereon and the lamp lead seating portion is formed of a part of the chassis.

The lamp lead seating portion has a blade and a seating groove formed on the blade.

The lamp socket further includes a contact terminal fastened to the lamp lead seating portion for fixing the lamp lead seated on the lamp lead seating portion.

The contact terminal has a spring tab placed on the lamp lead seating portion and a gantry extending from the spring tab and pressing the lamp lead.

The lamp socket further includes a housing having a body provided with a receiving space covering the lamp lead seating portion and the contact terminal.

The backlight assembly further includes a first fastening portion fastening the lamp lead seating portion to the housing.

The backlight assembly further includes second fastening portion fastening the contact terminal to the housing.

The backlight assembly further includes a third fastening portion fastening the contact terminal to the lamp lead seating portion.

The blade of the lamp lead seating portion is formed by cutting a part of the chassis and bending the cut portion perpendicularly to an receiving face of the chassis.

The backlight assembly further includes light-shield member covering through-holes formed in the chassis.

The lamp leads are a first lamp lead for applying power and a second lamp lead for grounding which is fixed by the lamp socket.

The backlight assembly further includes: a plurality of optical sheets; and side mold frames fastened to a first side and a second side of the chassis to support the optical sheets, wherein the side mold frames are disposed in contact with the housing of the lamp socket.

The lamp lead is fixed in the seating groove of the lamp lead seating portion by forced-fitting or soldering.

According to an exemplary embodiment of the invention, a liquid crystal display is provided which includes a backlight assembly having the above configuration, and a liquid crystal display panel disposed on the backlight assembly to display images.

According to an exemplary embodiment of the invention, a backlight assembly includes: a chassis provided with a receiving space; side mold frames fastened to the chassis; lamps including of a lamp tube and a lamp lead provided at both ends of the lamp tube; and first lamp sockets disposed inside the chassis to fix and apply power to the lamps.

The first lamp socket includes: a first lamp lead seating portion having a blade; a seating face extended from the blade; and a first contact terminal having a spring tab, which is placed on the first lamp lead seating portion, to fix the lamp lead which is seated on the first lamp lead seating portion in order to seat the lamp lead. The blade of the first lamp lead seating portion is formed of a part of the chassis.

According to an exemplary embodiment of the invention, a backlight assembly includes: a chassis provided with a receiving space; side mold frames fastened to the chassis; lamps each including a lamp tube and a lamp lead provided at both ends of the lamp tube; second lamp sockets disposed inside the chassis to fix and apply power to the lamps; and an inverter unit including an inverter for supplying power to the lamps and a circuit board equipped with the inverter. The second lamp socket includes: a second lamp lead seating portion having a fourth body, a seating face extended from the fourth body, and a contact portion extended from the fourth body to be in contact with the circuit board of the inverter unit, in order to seat the lamp lead; a second contact terminal having a fifth body placed on the second lamp lead seating portion to fix the lamp lead which is seated on the second lamp lead seating portion; and a guide having a sixth body and an accommodating portion formed on the sixth body to accommodate the second lamp lead seating portion, in order to fix the second lamp lead seating portion.

### BRIEF DESCRIPTION OF THE DRAWINGS

The above and other features and advantages of the present invention will become more apparent by describing in detail preferred embodiments thereof with reference to the attached drawings in which:

FIG. 1 is an exploded perspective view of a lamp socket according to a first embodiment of the invention;

FIG. 2A is an exploded perspective view of a contact terminal of the lamp socket shown in FIG. 1 and a housing;

FIGS. 2B and 2C are a perspective view and an opened-up perspective view of the housing and the contact terminal fastened, respectively;

FIGS. 3A and 3B are perspective views of a lamp socket with a lamp connected;

FIG. 4A is an exploded perspective view of a lamp socket according to a second embodiment of the invention;

FIG. 4B is a perspective view of the lamp socket with a lamp connected;

FIG. 5A is an exploded view of a lamp socket according to a third embodiment of the invention;

FIG. 5B is a perspective view of the lamp socket with a lamp connected;

FIG. 6A is an exploded perspective view of a lamp socket according to a fourth embodiment of the invention;

FIG. 6B is a perspective view of the lamp socket with a lamp connected;

FIG. 7A is an exploded perspective view of a lamp socket according to a fifth embodiment of the invention;

FIG. 7B is a perspective view of the lamp socket with a lamp connected;

FIG. 8A is an schematic perspective view of a lamp socket according to a sixth embodiment of the invention;

FIG. 8B is a perspective view of the lamp socket with a lamp connected;

FIG. 9 is an exploded perspective view of a backlight assembly equipped with lamp sockets according to an embodiment of the invention;

FIG. 10 is a partial enlarged view of the backlight assembly shown in FIG. 9;

FIG. 11 is a schematic view illustrating arrangement of a lamp socket and a side mold frame;

FIG. 12 is an exploded perspective view of a backlight assembly equipped with first lamp sockets according to a seventh embodiment of the invention;

FIG. 13 is a schematic perspective view of a first lamp lead seating portion;

FIG. 14A is an exploded perspective view of a side mold frame and a first contact terminal;

FIG. 14B is a perspective view of the side mold frame and the first contact terminal fastened together;

FIGS. 15A to 15C are an opened-up perspective view, a cross-sectional view, and a schematic perspective view of the first lamp socket with a lamp connected;

FIG. 16 is a perspective view of an exemplary modification for the first contact terminal;

FIGS. 17A and 17B are front and rear exploded perspective views, respectively, of a backlight assembly equipped with second lamp sockets according to an eighth embodiment of the invention;

FIGS. 18A to 18C are an opened-up perspective view and front and rear perspective views of the second lamp socket with a lamp connected, respectively;

FIGS. 19A and 19B are perspective views of a second lamp lead seating portion;

FIGS. 20A and 20B are perspective views illustrating the fastening way of the second lamp lead seating portion to a guide;

FIG. 21 is a schematic perspective view of the guide;

FIG. 22 is a schematic perspective view of an exemplary modification for the guide;

FIGS. 23A to 23E show the connected structure of the second lamp socket and a lamp; and

FIG. 24 is an exploded perspective view of a backlight assembly equipped with the first lamp sockets and the second lamp sockets according to a ninth embodiment of the invention.

### DESCRIPTION OF THE PREFERRED EMBODIMENTS

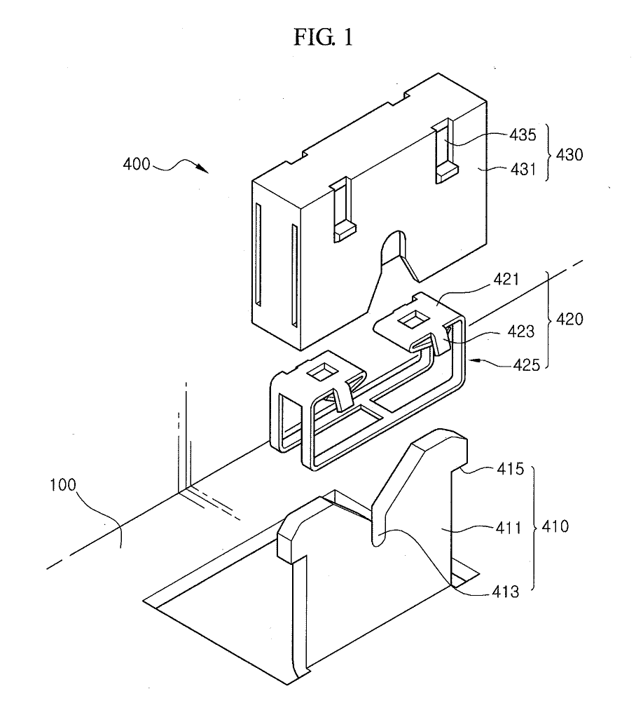

FIG. 1 is an exploded perspective view of a lamp socket according to a first embodiment of the invention.

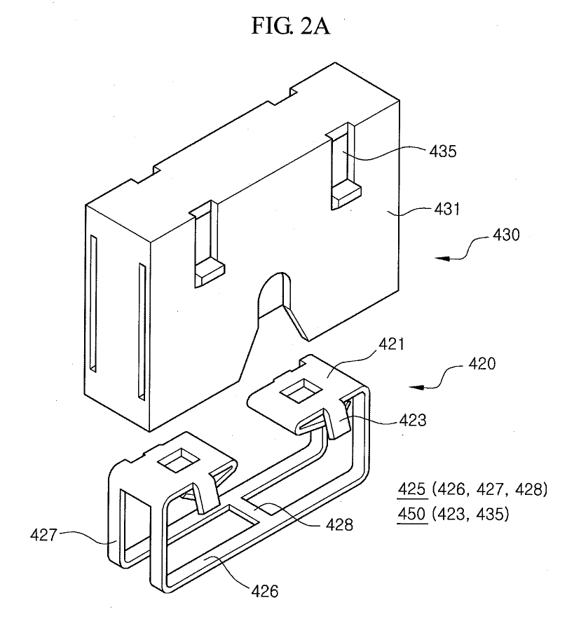

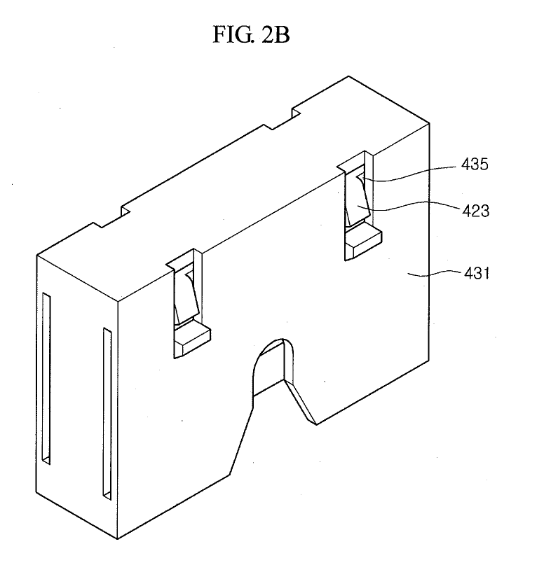

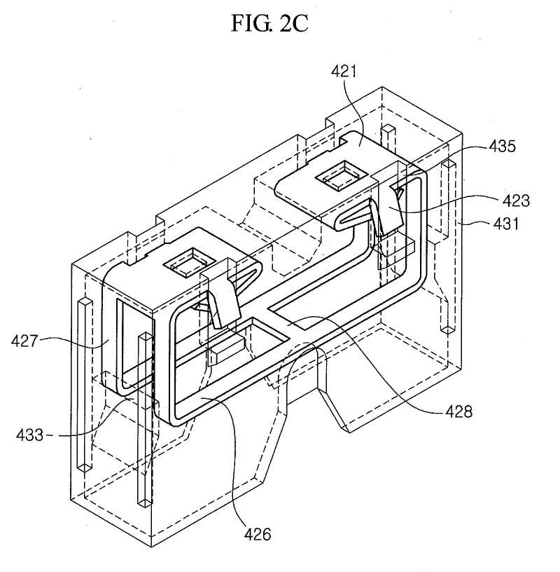

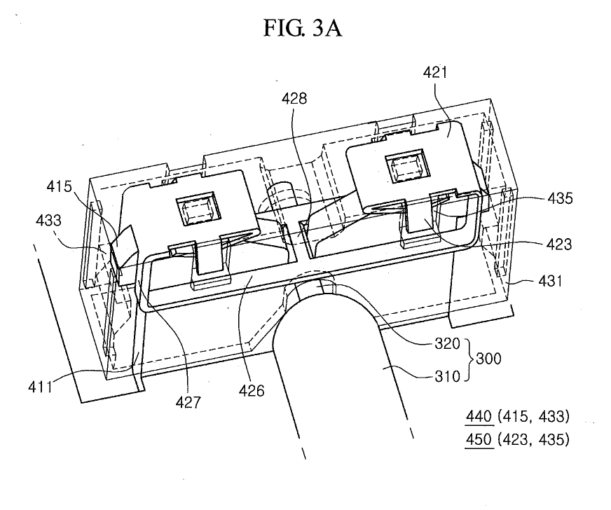

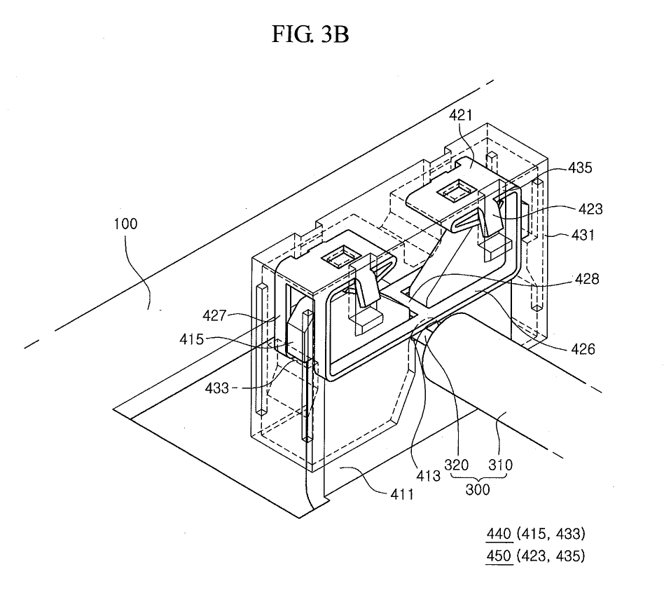

Referring to FIG. 1, a lamp socket 400 has a lamp lead seating portion 410, a contact terminal 420, a housing 430, a first fastening portion (not shown, see FIGS. 3A and 3B) and a second fastening portion (not shown, see FIGS. 2A, 3A and 3B).

The lamp lead seating portion 410 is grounded as well as providing a space to seat a lamp lead of a lamp (not shown), and the contact terminal 420 is disposed on the lamp lead seating portion 410 to press the lamp lead so that the lamp lead is fixed to the lamp lead seating portion 410. The lamp lead seating portion 410 is grounded through a chassis 100 because the lamp lead seating portion 410 is a part of the chassis 100. The housing 430 covers the lamp lead seating portion 410 and the contact terminal 420 and maintains contact between the lamp lead seating portion 410 and the contact terminal 420. The first fastening portion fastens the housing 430 to the lamp lead seating portion 410 and the second fastening portion fastens the contact terminal 420 to the housing 430. The structure of each component of the lamp socket is described in detail hereafter with reference to the accompanying drawings.

FIG. 2A is an exploded perspective view of the contact terminal and the housing of the lamp socket shown in FIG. 1, FIGS. 2B and 2C are a perspective view and an opened-up perspective view of the contact terminal and the housing fastened, respectively, and FIGS. 3A and 3B are perspective views of the lamp socket with a lamp fixed.

Referring to FIGS. 2A to 2C, the contact terminal 420 has a spring tab 421, second fastening protrusions 423, and a gantry 425; and the housing 430 has a body 431, stops 433, and second fastening holes 435. The contact terminal 420 is fastened to the housing 430 by the second fastening portion 450 which includes the second fastening protrusions 423 of the contact terminal 420 and the second fastening holes 435 of the housing 430.

The spring tab 421 of the contact terminal 420, formed in a rectangular plate shape, is divided into two parts spaced apart by a predetermined distance and supports the gantry 425. The spring tab 421 may bend as shown in the figures, but is not limited thereto and may be formed in a variety of shapes. For example, the spring tab 421 may be formed in a single plate or may be bent corresponding to the shape of the sidewalls of the lamp lead seating portion 410.

The gantry 425 includes a first pressing portion 426, a second pressing portion 427, and a third pressing portion 428. The first pressing portion 426 extends down from an end of the spring tab 421, bends and extends in parallel with the spring tab 421, and then extends up and connects to the other end of the spring tab 421. Specifically, the first pressing portion 426 is formed in a bar shape and each end of the first pressing portion 426 is perpendicularly bent toward the spring tab 421 to be connected each end of the spring tab 421, respectively.

The second pressing portion 427 is shaped corresponding to the first pressing portion 426, spaced apart from the first pressing portion 426. Specifically, the second pressing portion 427 is formed in a bar shape and each end of the second pressing portion 427 is perpendicularly bent toward the spring tab 421 to be connected to each end of the spring tab 421, respectively.

The third pressing portion 428 connects the first pressing portion 426 with the second pressing portion 427. The third pressing portion 428 is formed at a position corresponding to a seating groove 413 of the lamp lead seating portion 410 (see FIGS. 1 and 3B) to be inserted in the seating groove 413. In the embodiment, the gantry 425 with the third pressing portion 428 is exemplified, but the third pressing portion 428 may be removed, if needed.

The second fastening protrusions 423 are extended and protruded from the spring tab 421. In the embodiment, four second fastening protrusions 423 are formed, but the number is not limited thereto.

The body 431 of the housing 430 has a receiving space for covering the lamp lead seating portion 410 and the contact terminal 420. The body 431 is formed in a box shape that is open at one side having a receiving space inside.

The second fastening holes 435 are formed to correspond to the shape, size, and position of the second fastening protrusions 423, on sidewalls of the body 431, so that the second fastening protrusions 423 are fitted in the second fastening holes 435.

The contact terminal 420 is inserted into the receiving space defined inside the body 431 of the housing 430 and the second fastening protrusions 423 are inserted into the second fastening holes 435, so that the contact terminal 420 is fastened to the housing 430 (see FIGS. 2B and 2C).

Referring to FIGS. 3A and 3B, the lamp lead seating portion 410 has a blade 411, a seating groove 413, and fastening ears 415. The lamp lead seating portion 410 is fastened into the housing 430 by the first fastening portion 440 which includes the lamp lead seating portion 410, the fastening ears 415, and the stops 433 inside the housing 430.

The blade 411 is a part of the chassis 100. Specifically, the blade 411 is formed by cutting a part of an receiving face of the chassis 100 into a predetermined shape (for example, U-shape) and then bending the cut portion perpendicularly to the receiving face of the chassis 100.

The seating groove 413 is formed from the upper side toward the center of the blade 411 to have a width the same as or larger than the diameter of a lamp lead 320 to seat the lamp lead 320.

The first fastening protrusion 415 is protruded on the left and right upper sides of the blade 411 and held by the stops 433 formed inside the receiving space of the body 431 of the housing 430.

Considering the fastened structure of a lamp 300 and a lamp socket 400, the lamp 300 includes a lamp tube 310 and lamp leads 320 provided at both ends of the lamp tube 310.

Inside the lamp tube 310, a layer of fluorescent material (not shown) is provided and electric discharge gas (not shown) is injected. The lamp leads 320 are provided at both ends of the lamp tube 310 to apply power. The lamp leads 320 are a hot lamp lead and a ground lamp lead. Power output from an inverter (not shown) is applied to the hot lamp lead, while the ground lamp lead is grounded. A cold cathode fluorescent lamp is used as the lamp 300 in the embodiment, but the type of lamp 300 is not limited thereto. A lamp socket according to the embodiment of the present invention is connected with the ground lamp lead among the hot lamp lead and the ground lamp lead.

The lamp lead 310 is seated in the seating groove 413 of the lamp lead seating groove 410. The contact terminal 420 is inserted into the receiving space of the housing 430 and fastened to the housing 430 by the second fastening portion 450, that is, the second fastening protrusions 423 and the second fastening holes 435. The lamp lead seating portion 410 is inserted into the receiving space of the housing 430, which is fastened to the contact terminal 420, and fastened to the housing 430 by the first fastening portion 440, that is, the fastening ears 415 and the stops 433.

The lamp lead 320 is seated in the seating groove 413 of the blade 411, which is a part of the chassis 100, and forms a ground structure by being in contact with the chassis 100. The gantry 425 of the contact terminal 420 presses the lamp lead 320 which is seated in the seating groove 413 being in contact with the blade 413, and prevents the lamp lead 320 from floating. According to the embodiment, the gantry 425 has the first to third pressing portion 426 to 428, each of which presses the lamp lead 320, but it is not limited thereto. For example, the third pressing portion 428 may be removed, and in this case, only the first and second pressing portions 426, 427 are used to press the lamp lead 320.

As described above, by forming the blade 411 of the lamp lead seating portion 410 of the lamp socket 400 out of a part of the chassis 100 to seat the lamp lead 320, and by using the contact terminal 420 and housing 430 to fix the lamp lead 320; it is possible to reduce the number of the components and materials cost as compared to lamp socket configurations in the related art. Further, a lamp is simply connected to a lamp socket, which also saves manufacturing time.

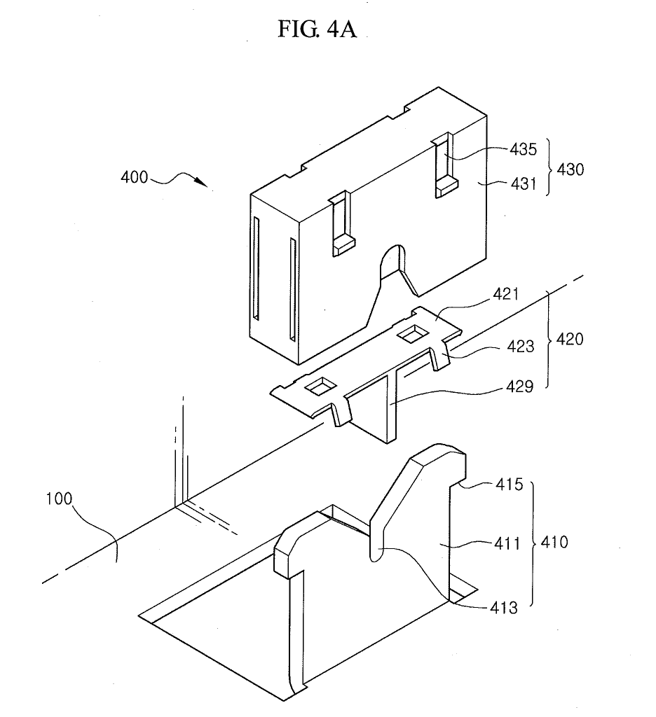

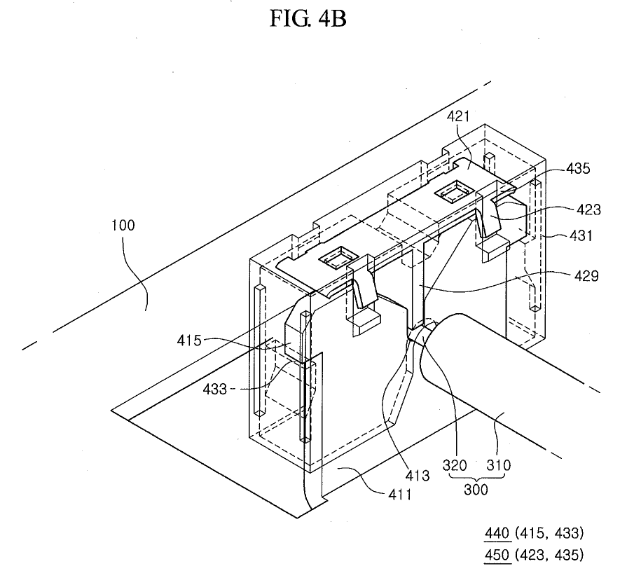

FIG. 4A is an exploded perspective view of a lamp socket according to a second embodiment of the invention and FIG. 4B is a perspective view of the lamp socket with a lamp connected. The second embodiment shown in FIGS. 4A and 4B has similar structures as the first embodiment, except for that of a contact terminal; therefore the differences in the structure are mainly described hereafter.

Referring to FIGS. 4A and 4B, a contact terminal 420 has a spring tab 421, second fastening protrusions 423, and a gantry 429. The spring tab 421 of the contact terminal 420 is formed in a rectangular plate shape and supports the gantry 429. However, the spring tab 421 is not limited to the above-mention shape and may be formed in a variety of shapes.

The gantry 429 is extended from one side, that is, the bottom side of the spring tab 421, corresponding to a position of a seating groove 413. The spring tab 421 and the gantry 429 are formed to have generally a T-shape.

The second fastening protrusions 423 are protruded from the spring tab 421. According to the embodiment, four second protrusions 423 are formed, but the number is not limited thereto.

In the fastened structure of a lamp 300 and a lamp socket 400, a lamp lead 320 is seated in the seating groove 413 of the blade 411 that is a part of a chassis 100, and forms a ground structure by being in contact with the chassis 100. The gantry 429 of the contact terminal 420 is inserted into the seating groove 413 of the blade 411 and presses the lamp lead 320 which is seated in the seating groove 413 preventing the lamp lead 320 from floating.

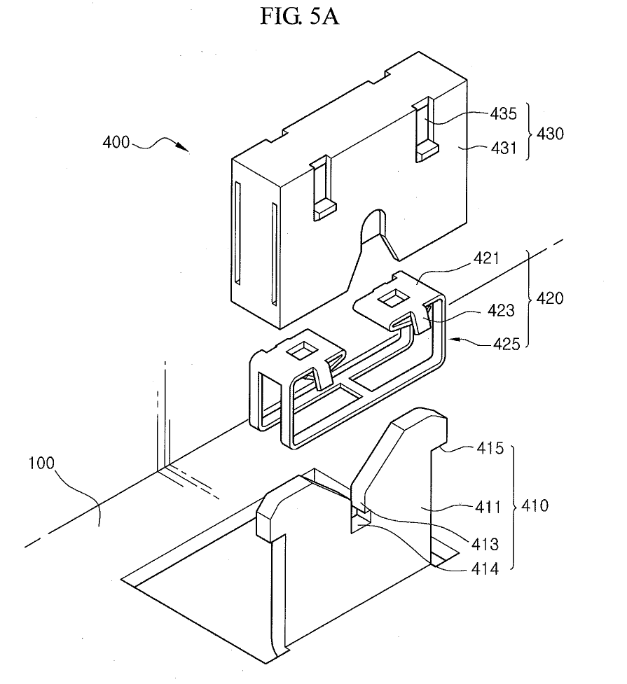

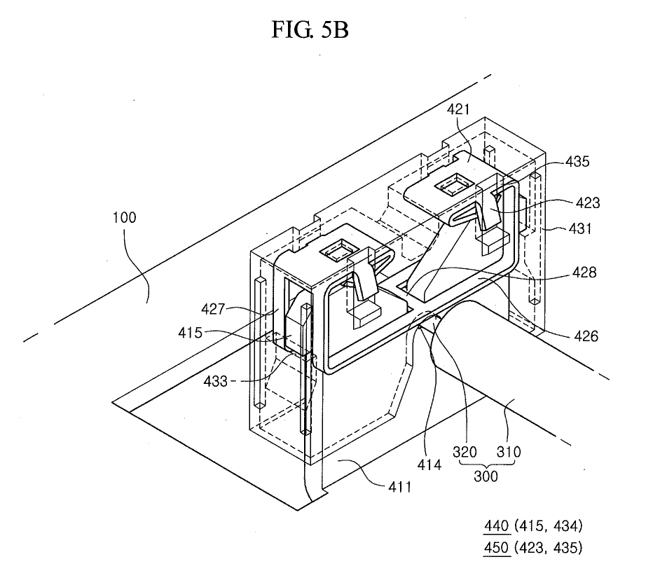

FIG. 5A is an exploded view of a lamp socket according to a third embodiment of the invention and FIG. 5B is a perspective view of the lamp socket with a lamp connected. The third embodiment shown in FIGS. 5A and 5B is similar in configuration to the above embodiments except for the structure of a lamp lead seating portion; therefore, the differences in the structure are mainly described hereafter.

Referring to FIGS. 5A and 5B, a lamp lead seating portion 410 has a blade 411, a first seating groove 413, a second seating groove 414, and fastening ears 415.

The blade 411 is formed of a part of a chassis 100. Specifically, the blade 411 is formed by cutting the receiving face of the chassis 100 into a predetermined shape (for example, U-shape) and then bending the cut portion perpendicularly to the receiving face of the chassis 100.

The first seating groove 413 is formed from the upper side of the blade 411 toward the center to have a width the same as or larger than the diameter of a lamp lead 320 to seat the lamp lead 320.

The second seating groove 414 is extended in a crossing direction of the first seating groove 413. The first and second seating grooves 413, 414 generally form an L-shape.

In the connected structure of a lamp 300 and a lamp socket 400, the lamp lead 320 is inserted into the first seating groove 413 and then seated in the second seating groove 414 forming a ground structure by being in contact with the chassis 100. A gantry 425 of the contact terminal 420, which is in contact with the blade 411 of the gantry 425, presses the lamp lead 320 which is seated in the seating groove 413 to prevent the lamp lead 320 from floating. In the embodiment, first and second pressing portions 426, 427 of the gantry 425 press the lamp lead 320 from the top and the third pressing portion 428 which is inserted into the first seating groove 413 presses the lamp lead 320 at the sides.

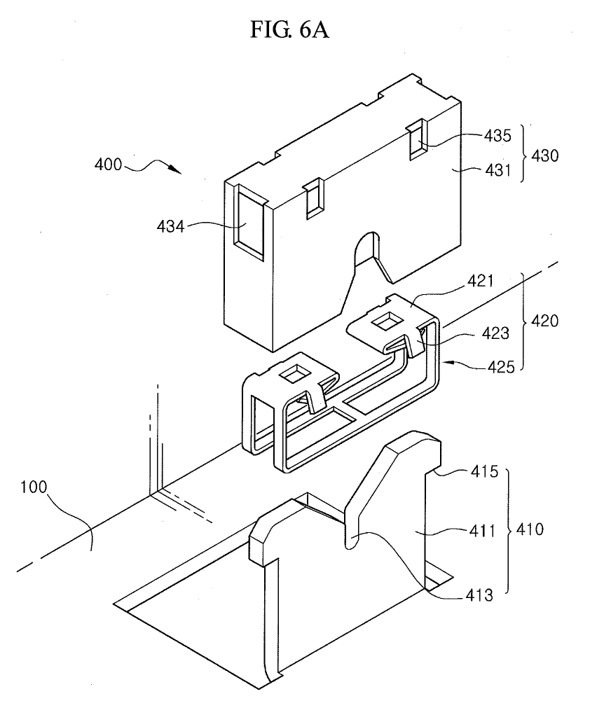

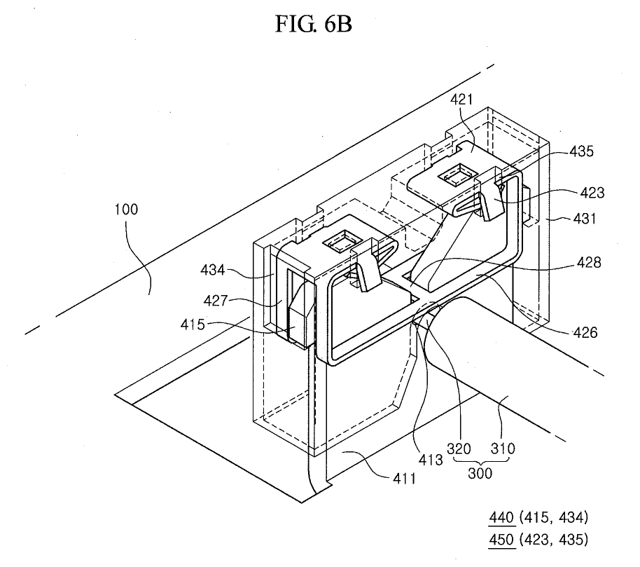

FIG. 6A is an exploded perspective view of a lamp socket according to a fourth embodiment of the invention and FIG. 6B is a perspective view of the lamp socket with a lamp connected. The fourth embodiment shown in FIGS. 6A and 6B has similar configurations to the above embodiments except for the structure of a housing; therefore, the differences in the structure are mainly described hereafter.

Referring to FIGS. 6A and 6B, a body 431 of a housing 430 has a receiving space that covers a lamp lead seating portion 410 and a contact terminal 420. The body 431 is formed in a box shape that is open at one side, with a receiving space inside.

First fastening holes 434 and second fastening holes 435 are formed through the body 431. Fastening ears 415 of the lamp lead seating portion 410 protrude from the left and right sides of the blade. The first fastening holes 434 are formed at the left and right sides of the body 431, corresponding to the fastening ears 415.

The second fastening holes 435 are formed to correspond to the shape, size, and position of the second fastening protrusions 423, at front and rear sides of the body 431, so that the second fastening protrusions 423 is fitted in the second fastening slots 435.

Fastening structures of a contact terminal and a housing, and a lamp lead seating portion and a housing according to the embodiments of the invention may be modified in various ways, other than the above structures.

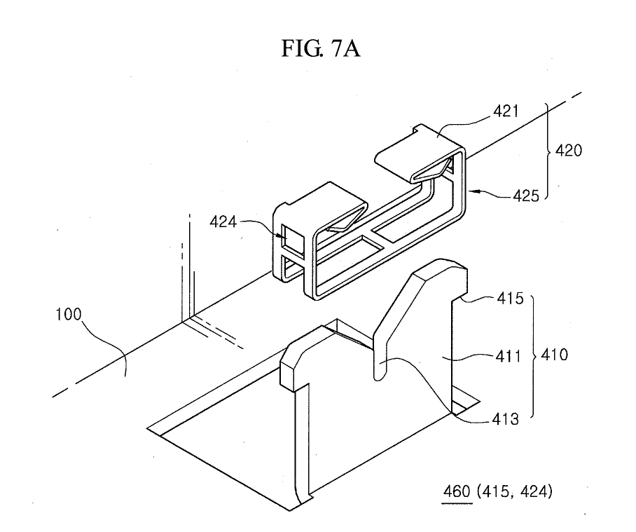

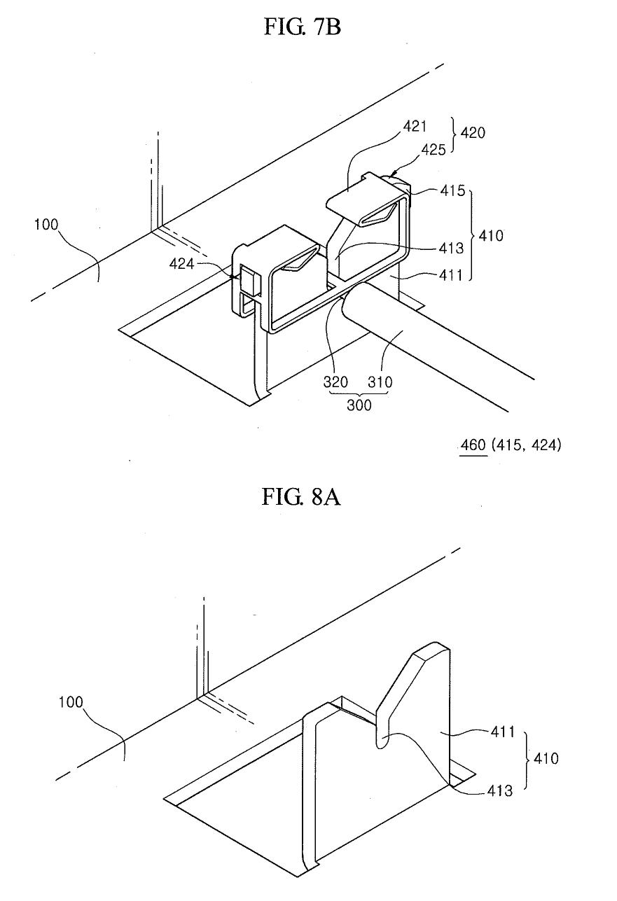

FIG. 7A is an exploded perspective view of a lamp socket according to a fifth embodiment of the invention and FIG. 7B is a perspective view of the lamp socket with a lamp connected. A lamp socket according to the fifth embodiment of the invention is not provided with a housing, different from the above embodiments, and includes a lamp lead seating portion 410, a contact terminal 420, and a third fastening portion 460.

The lamp lead seating portion 410 has a blade 411, a seating groove 413, and fastening ears 415, and the contact terminal 420 has a spring tab 421, third fastening holes 424 (see FIG. 7A), and a gantry 425. The contact terminal 420 is fastened to the lamp lead seating portion 410 by the third fastening portion 460. The third fastening portion 460 includes the fastening ears 415 of the lamp lead seating portion 410 and the third fastening holes 424 of the contact terminal 420. The third fastening hole 424 is formed at both sides of the gantry 425, corresponding to the position and size of the first protrusions 415. However, the configuration and shape of the third fastening portion are not limited thereto and may be modified in a variety of ways to fasten the contact terminal 420 to the lamp lead seating portion 410.

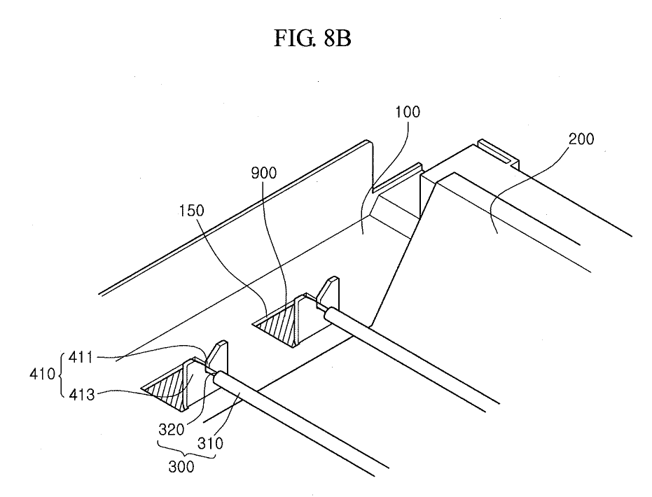

FIG. 8A is a schematic perspective view of a lamp socket according to a sixth embodiment of the invention and FIG. 8B is a perspective view of the lamp socket with a lamp connected.

Referring to FIGS. 8A and 8B, a lamp socket according to the sixth embodiment of the invention includes a lamp lead seating portion 410 only. The lamp lead seating portion 410 has a blade 411 and a seating groove 413.

The blade 411 is formed by cutting a part of the receiving face of a chassis 100 into a predetermined shape (for example, U-shape) and then bending the cut portion perpendicularly to the receiving face of the chassis 100.

The seating groove 413 is formed from the upper side toward the center of the blade 411. The seating groove 413 is formed to have a width the same as or smaller than the diameter of a lamp lead 320 to fix the lamp lead 320 by forced fitting.

In an exemplary modification, the lamp lead 320 may be fixed in the seating groove 413 of the lamp lead seating portion 410 by soldering, while it is fixed in the seating groove 413 by forced fitting in this embodiment. In the case of soldering, the width of the seating groove 413 is formed to be the same as or smaller than the diameter of the lamp lead 320.

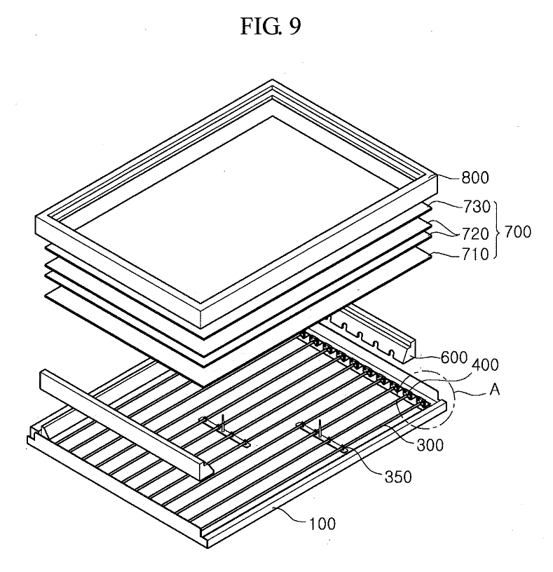

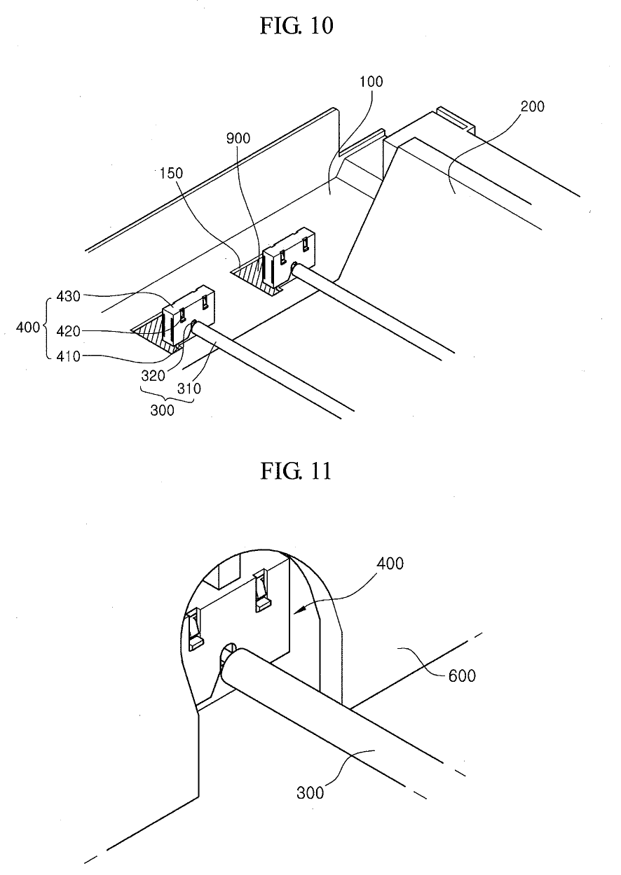

FIG. 9 is an exploded perspective view of a backlight assembly equipped with lamp sockets according to the above embodiments, FIG. 10 is a partially enlarged view of the backlight assembly of FIG. 9, and FIG. 11 is a schematic view illustrating arrangement of the lamp socket and a side mold frame.

Referring to FIGS. 9 to 11, a backlight assembly includes a chassis 100, a reflective plate 200, lamps 300, lamp supporters 350, lamp sockets 400, side mold frames 600, optical sheets 700, a mold frame 800, and a light-shield member 900.

The chassis 100 is provided with a receiving space defined by an receiving face and sidewalls. A reflective plate 200 is disposed on the receiving face of the chassis 100 to reflect light emitted from the lamps 300 towards a liquid crystal display panel (not shown).

The lamp sockets 400 are arranged at one side on the receiving face of the chassis 100 and the lamp sockets are also arranged at the other side (not shown). The lamps 300 are fixed by the lamp sockets and supplied with power. And the lamp supporters 350 are disposed under intermediate portions of the lamps 300 to support them. As described above, the lamp sockets 400 fix the ground lamp leads among the lamp leads to form ground structures.

Each lamp socket 400 includes a lamp lead seating portion 410 to seat a lamp lead 320 using a part of the chassis 100; and a contact terminal 420 and a housing 430 to fix the lamp lead 320 which is seated in the lamp lead seating portion 410. As a result, the number of components and materials cost may possibly be reduced compared to lamp sockets in the related art. Further, lamps are simply connected to lamp sockets, which also reduce manufacturing time.

The side mold frame 600 is fastened to the left and right sidewalls of the chassis 100. And optical sheets 700, that is, a diffusion plate, a prism sheet 720, and a protective sheet 730 are sequentially stacked on the side mold frame 600. The side mold frames 600 are disposed above the lamp sockets 400 and get in contact with the housings 430 of the lamp sockets 400. As a result, the side mold frames 600 apply a predetermined pressure to the lamp sockets 400 to fix the lamp leads 320 more firmly by the lamp lead seating portions 410 and the contact terminals 420.

Since parts of the chassis 100 are cut and bent to be used as parts of the lamp sockets 400, through-holes 150 with a predetermined shape are formed in the chassis 100. To block light emitted from the lamps 300 past the through-holes 150 the light-shield member 900 is provided on the chassis 100. Black tape may be attached as the light-shield member 900 on the receiving face of the chassis or on the opposite face.

A liquid crystal display may be achieved by arranging a liquid crystal display panel that displays images on the backlight assembly according to the above embodiment of the invention.

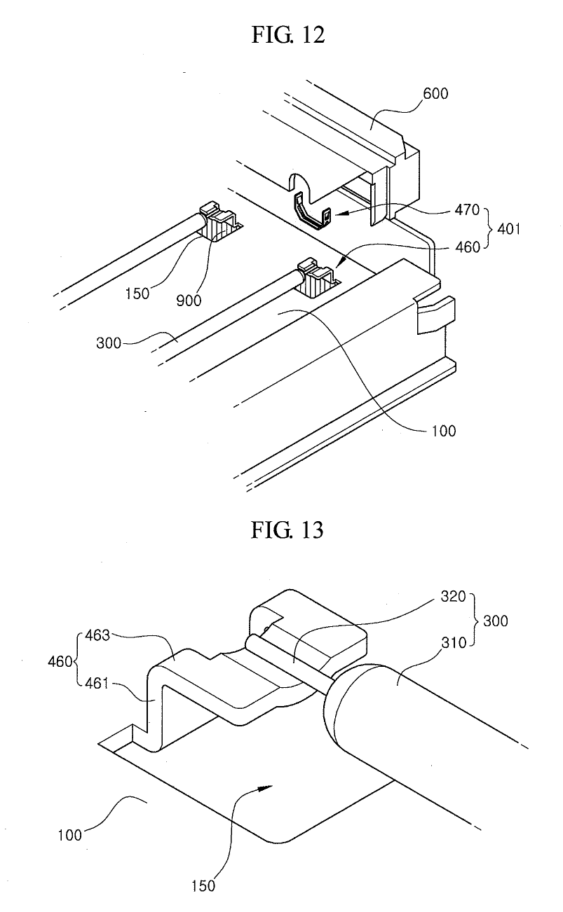

FIG. 12 is an exploded perspective view of a backlight assembly equipped with first lamp sockets according to a seventh embodiment of the invention.

Referring to FIG. 12, a backlight assembly according to the seventh embodiment includes a chassis 100, lamps 300, first lamp sockets 401, side mold frames 600, and a light-shield member 900. The first lamp socket 401 has a first lamp lead seating portion 460 and a first contact terminal 470.

Each first lamp lead seating portion 460 provides an area to seat a lamp lead of the lamp 300 as well as being grounded. The first contact terminal 470 are disposed on the first lamp lead seating portions 460 to press the lamp leads so that the lamp leads can be fixed on the first lamp lead seating portions 460. As such, the first contact terminals 470 are fastened to the side mold frames 600 by first fastening portions (not shown) and disposed on the first lamp lead seating portions 460.

Since the first lamp lead seating portion 460 is formed of a part of the chassis 100, lamp leads are grounded through the chassis 100. A part of the chassis 100 is bent to form the first lamp lead seating portion 460 and, as a result, through-hole 150 is formed in the chassis 100. The light-shield member 900 is disposed to block light emitted from the lamp 300 to the outside the chassis through the through-hole 150. A black tape may be used as the light-shield member 900, but it is not limited thereto and a variety of light-shield members may be used. The structure of each part of the lamp socket is described hereafter in detail with reference to the following drawings.

FIG. 13 is a schematic perspective view of the first lamp lead seating portion.

Referring to FIG. 13, the first lamp lead seating portion has a blade 461 and a seating face 463.

The blade 461 is formed of a part of the chassis 100. Specifically, the blade 461 is formed by cutting the receiving face of the chassis 100 into a predetermined shape (for example, U-shape) and followed by bending the cut portion perpendicularly to the receiving face of the chassis 100.

The seating face 463 is formed by extending from the blade 461, and bending to be parallel to the receiving face of the chassis 100. Specifically, the seating face 463 is bent perpendicular to the blade 461 and has a recess at the central portion to guide the seating position of the lamp lead 320.

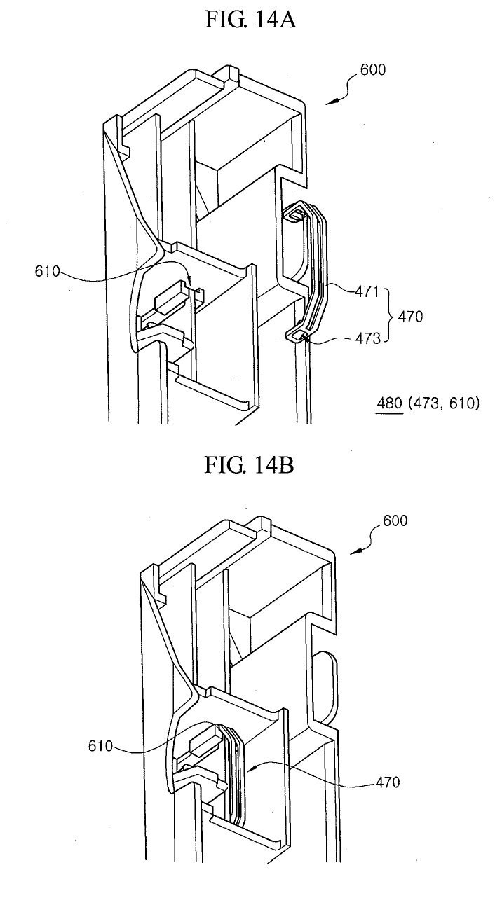

FIG. 14A is an exploded perspective view of the side mold frame and the first contact terminal, and FIG. 14B is a perspective view of the side mold frame with the first contact terminal fastened.

Referring to FIGS. 14A and 14B, the first contact terminal 470 has a spring tab 471 and first hooks 473, and first fastening grooves 610 are formed inside the side mold frame 600. The first contact terminal 470 is fastened to the side mold frame 600 by a first fastening portion 480, which includes the first hooks 473 of the first contact terminal 470 and the first fastening grooves 610 of the side mold frame 600.

The spring tab 471 of the first contact terminal 470 is formed in a rectangular shape and bent at both ends toward the side mold frame 600, resulting in U-shape approximately. The first hook 473 is formed at both ends of the spring tab 471. Further, the central portion of the spring tab 471 may be formed as a single part or divided into two parts by forming a rectangular hole.

The first hooks 473 at both ends of the spring tab 471 are fitted in the first fastening grooves 610 of the side mold frame 600.

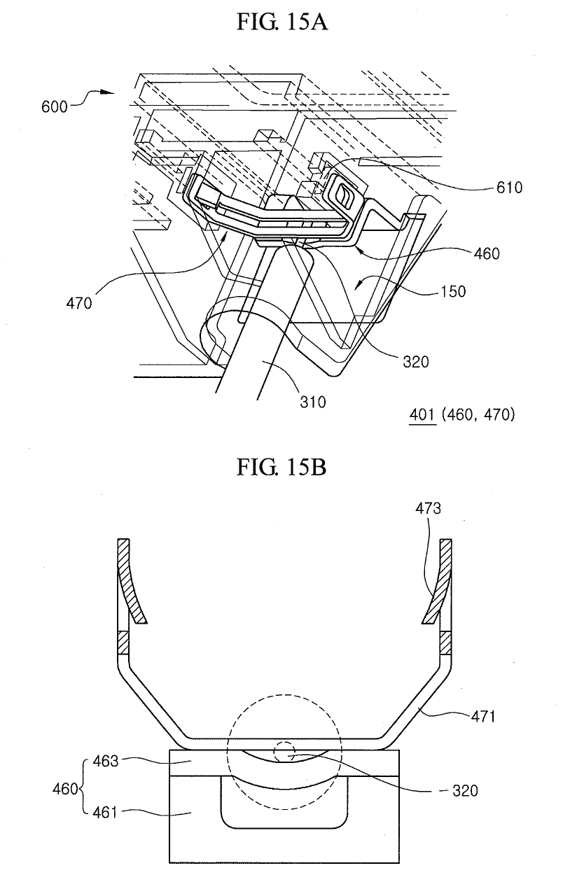

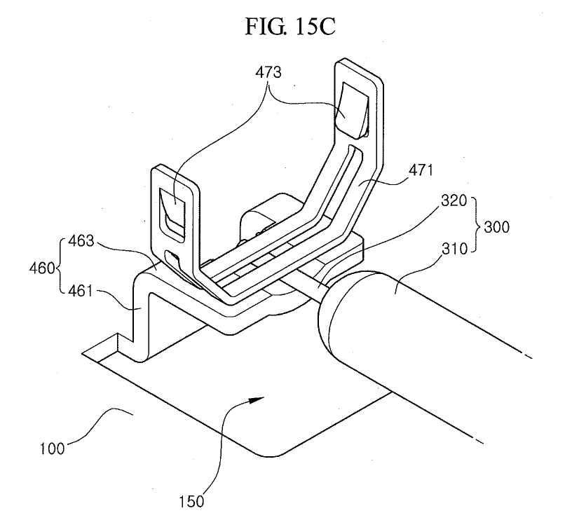

FIGS. 15A to 15C are an opened-up perspective view, a cross-sectional view, and a schematic perspective view of the first lamp socket with a lamp connected, respectively.

Referring to FIGS. 15A to 15C, in the connected structure of the lamp 300 and the first lamp socket 401, the lamp 300 includes a lamp tube 310 and lamp leads 320 provided at both ends of the lamp tube 310. Inside the lamp tube 310, a layer of fluorescent material (not shown) is provided and electric discharge gas (now shown) is injected. The lamp lead 320 is provided at both ends of the lamp tube 310 to apply power. The lamp leads 320 are a hot lamp lead and a ground lamp lead. Power output from an inverter (not shown) is applied to the hot lamp lead and the ground lamp lead is grounded. A cold cathode fluorescent lamp is used as the lamp 300 in the embodiment, but the type of lamp 300 is not limited thereto. The lamp socket according to the embodiment of the invention is connected with the ground lamp lead among the hot lamp lead and the ground lamp lead.

The lamp lead 320 is seated on the seating face 463 of the first lamp lead seating portion 460. The first hooks 473 of the first contact terminal 470 are fitted in the first fastening grooves 610 of the side mold frame 600. The side mold frame 600 where the first contact terminal 470 is inserted and fastened is disposed on the first lamp lead seating portion 460 where the lamp lead 320 is seated. As a result, the spring tab 471 of the first contact terminal 470 is in contact with the seating face 463 of the first lamp lead seating portion 460 and fixes the lamp lead 320 seated on the seating face 463 by pressing. Further, the side mold frame 600 is fixedly fastened to the chassis 100.

According to the configuration described above where the first lamp lead seating portion 460 of the lamp socket 401 is formed of a part of the chassis 100 to seat the lamp lead 320, and the first contact terminal 470 for fixing the lamp lead 320 is fastened to the side mold frame 600; the number of components and materials cost can possibly be reduced compared to lamp socket configurations in the related art. Further, a lamp is simply connected to a lamp socket, which also reduces manufacturing time.

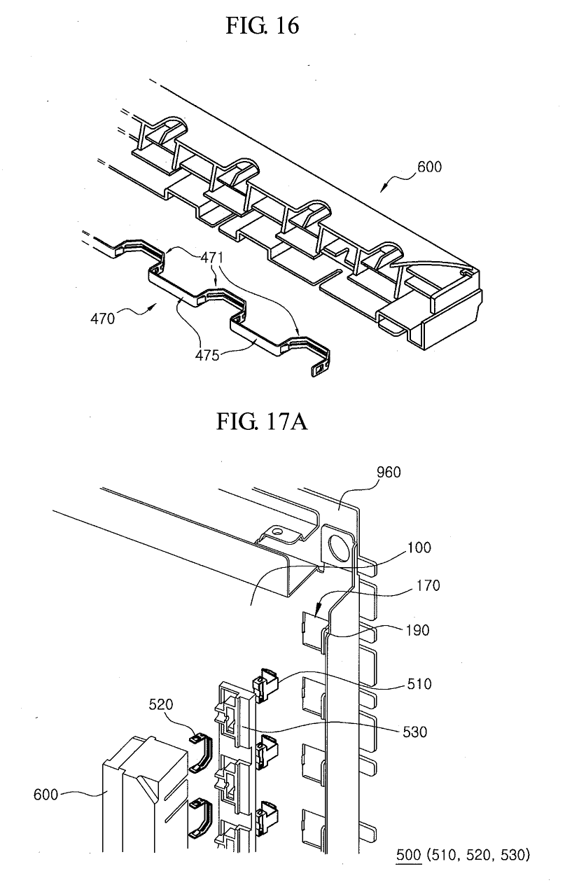

FIG. 16 is a perspective view of an exemplary modification of the first contact terminal.

Referring to FIG. 16, the first contact terminal 470 has a plurality of second bodies 471 and connecting portions 475 that connect each of the second bodies 471. Specifically, a connecting portion 475 is formed at both ends of each spring tab 471 to connect the next spring tab 471. Accordingly, the first contact terminal 470 is integrally formed. It is possible to reduce manufacturing time by integrally forming first contact terminal 470.

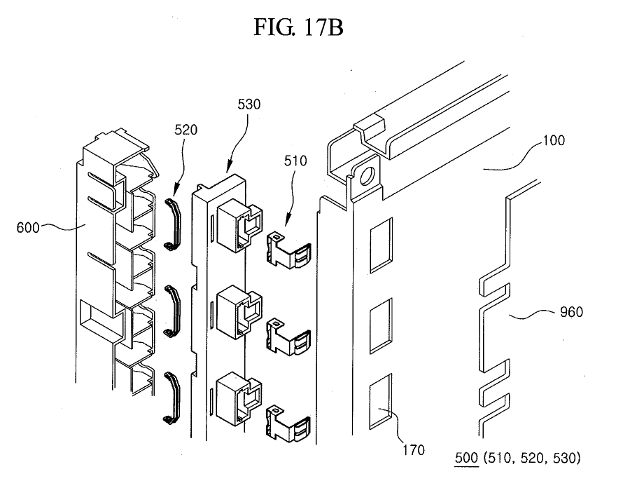

FIGS. 17A and 17B are front and rear exploded perspective views of a backlight assembly equipped with second lamp sockets according to an eighth embodiment of the invention.

Referring to FIGS. 17A and 17B, a backlight assembly according to the eighth embodiment of the invention includes a chassis 100, lamps (not shown), second lamp sockets 500, side mold frames 600, and a circuit board 960 of an inverter unit. Each second lamp socket 500 each has a second lamp lead seating portion 510, a second contact terminal 520, and a guide 530.

The second lamp lead seating portion 510 provides an area to seat a lamp lead and electrically connects a lamp with the inverter by contacting with the circuit board 960 of the inverter unit. The second contact terminal 520 is disposed on the second lamp lead seating portion 510 in order to press the lamp lead to be fixed on the second lamp lead seating portion 510. The second contact terminal 520 is fastened to the side mold frame 600 and disposed on the second lamp lead seating portion 510.

The guide 530 provides a space to insert the second lamp lead seating portion 510 in, in order to guide the second lamp lead seating portion 510 to a fixed position, and is fastened and fixed to the chassis 100.

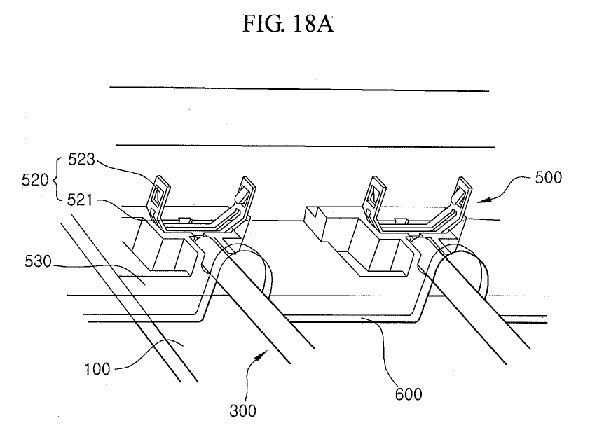

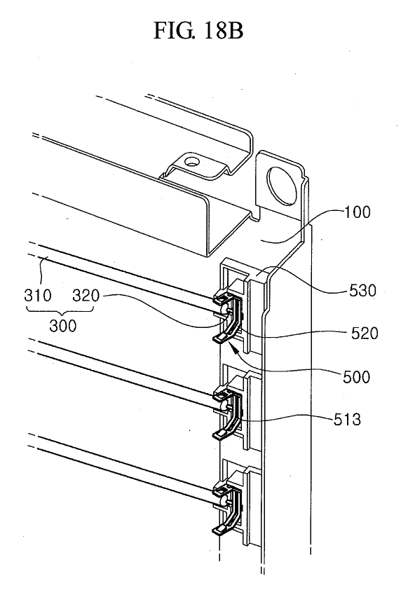

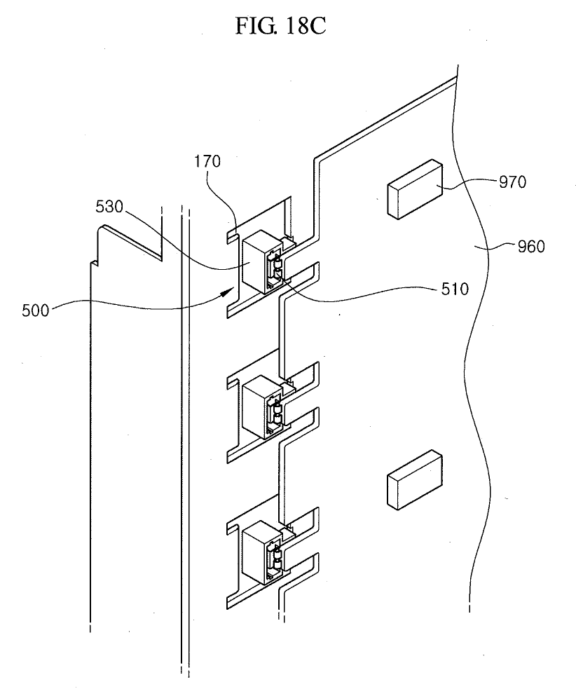

FIGS. 18A to 18C are an open-up perspective view, a front perspective view, and a rear perspective view of second lamp sockets with lamps connected.

Referring to FIGS. 18A to 18C, in the connected structure of lamps 300 and second lamp sockets 500, the lamp 300 includes a lamp tube 310 and lamp leads 320 provided at both ends of the lamp tube 310.

Inside the lamp tube 310, a layer of fluorescent material (not shown) is provided and electric discharge gas (now shown) is injected. The lamp lead 320 is provided at both ends of the lamp tube 310 for applying power. The lamp leads 320 are a hot lamp lead and a ground lamp lead. Power output from an inverter 970 is applied to the hot lamp lead and the ground lamp lead is grounded. A cold cathode fluorescent lamp is used as the lamp 300 in the embodiment, but the type of lamp 300 is not limited thereto. The second lamp socket 500 according to the embodiment of the invention is connected with the hot lamp lead among the hot lamp lead and the ground lamp lead.

The lamp lead 320 is seated on a seating face 513 of a second lamp lead seating portion 510. A second contact terminal 520 is fastened to a side mold frame 600 by a third fastening portion 550, which includes third hooks 523 of the second contact terminal 520 and third fastening grooves (not shown) of the side mold frame 600. The side mold frame 600 where the second contact terminal 520 is inserted and fastened is disposed on the second lamp lead seating portion 510 where the lamp lead 320 is seated. As a result, a fifth body 521 of the second contact terminal 520 is in contact with the seating face 513 of the second lamp lead seating portion 510, and fixes the lamp lead 320 which is seated on the seating face 513 by pressing it. Further, the side mold frame 600 is fastened and fixed to the chassis 100.

The guide 530 is provided with a receiving space where the second lamp lead seating portion 520 is inserted. A contact portion 517 of the second lamp lead seating portion 520 that has been inserted into the receiving space of the guide 530 protrudes out from the opposite side of the receiving face of the chassis 100 through a fastening hole 170, and it is also disposed to be electrically connected to a circuit board 960 equipped with the inverter 970.

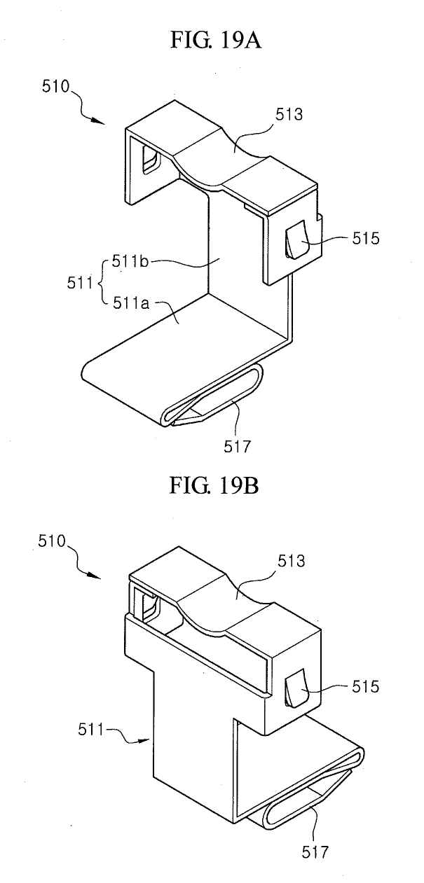

FIGS. 19A and 19B are perspective views of the second lamp lead seating portion.

Referring FIGS. 19A and 19B, the second lamp lead seating portion 510 of the second lamp socket 500 has a fourth body 511, a seating face 513, second hooks 515, and a contact portion 517.

The fourth body 511 has a base plate 511a and a sidewall 511b extended and bent from the base plate 511a. The fourth body 511 has approximately an L-shape.

The seating face 513 is formed by extending from the sidewall 511b of the fourth body and bending to face the base plate 511a, and has a recess at the central portion to guide the seating position of the lamp lead 320.

The second hook 515 is formed at both sidewalls 511b of the fourth body 511 and the contact portion 517 is formed by extending and bending from the base plate 511a of the fourth body 511.

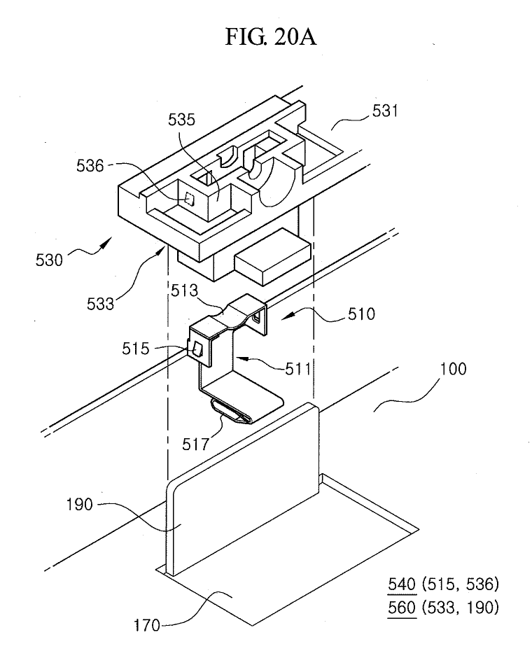

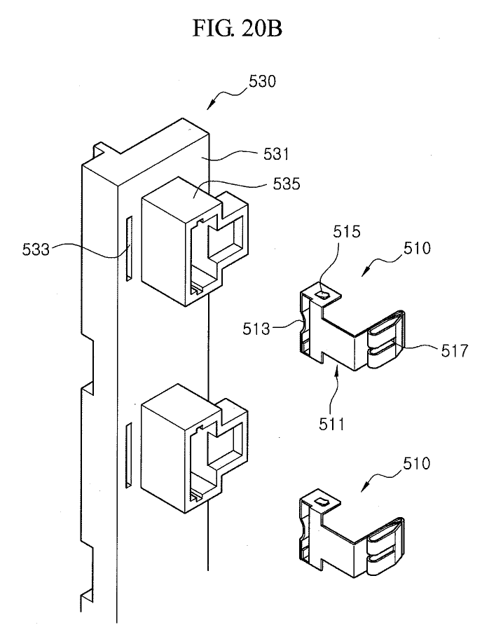

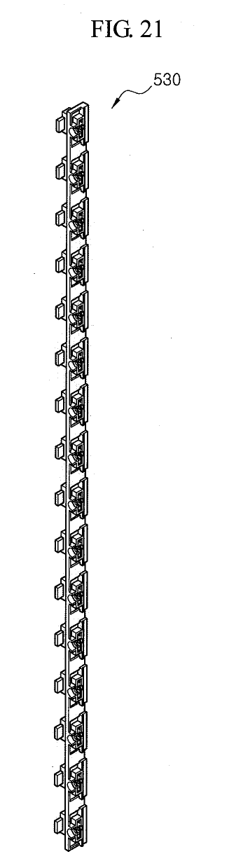

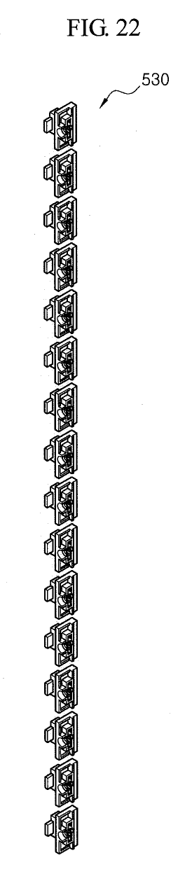

FIGS. 20A and 20B are perspective views illustrating how to fasten the second lamp lead seating portion to the guide, and FIG. 21 is a schematic perspective view of the guide. FIG. 22 is a schematic perspective view of am exemplary modification for the guide.

Referring to FIGS. 20A and 20B, the guide 530 has a sixth body 531 and an accommodating portion 535 formed on the sixth body 531 to accommodate the second lamp lead seating portion 510.

The accommodating portion 535 of the guide 530 is formed corresponding to a shape of the second lamp lead seating portion 510, and protrudes up and down from the sixth body 531. The guide 530 and the second lamp lead seating portion 510 are fastened by a second fastening portion 540 which includes second fastening grooves 536 formed inside of the accommodating portion 535 and second hooks 515 on the second lamp lead seating portion 510.

Further, the guide 530 is fastened to the chassis 100 by a fourth fastening portion 560 includes chassis-fastening grooves 533 formed on the sixth body 531 of the guide 530 and protrusions 190 formed on the chassis 100. The protrusions 190 are formed by cutting the receiving face of the chassis 100 into a predetermined shape (for example, U-shape) and then bending the cut portion perpendicularly to the receiving face of the chassis 100.

As shown in FIG. 22, a plurality of guides 530 may be integrally formed, or a plurality of guides 530 may be formed individually.

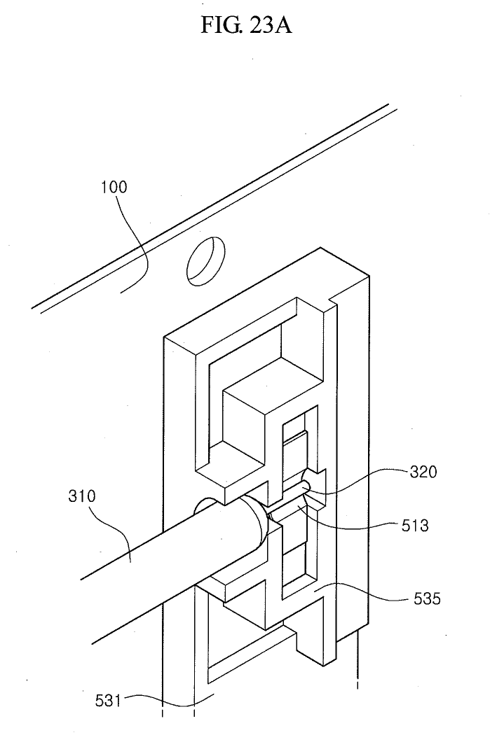

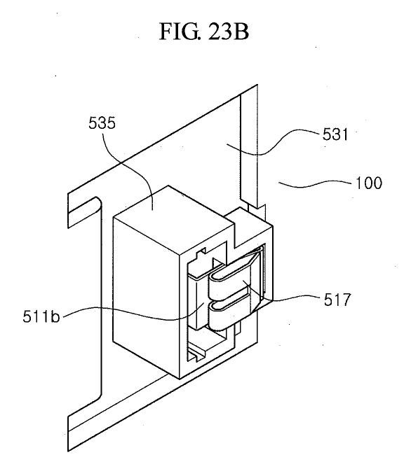

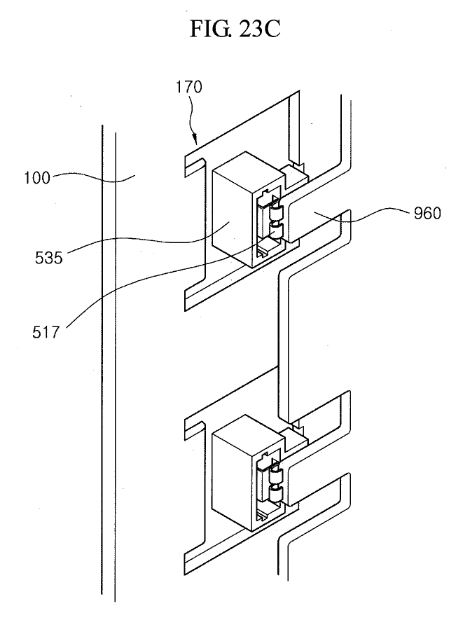

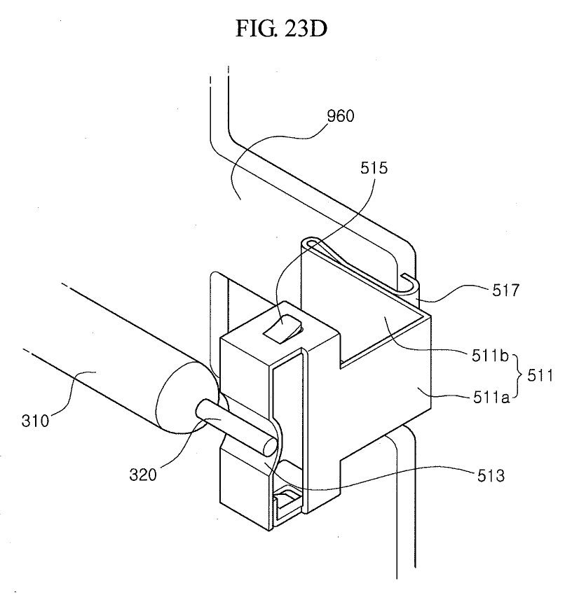

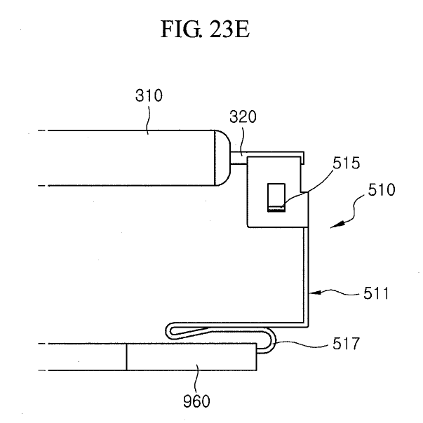

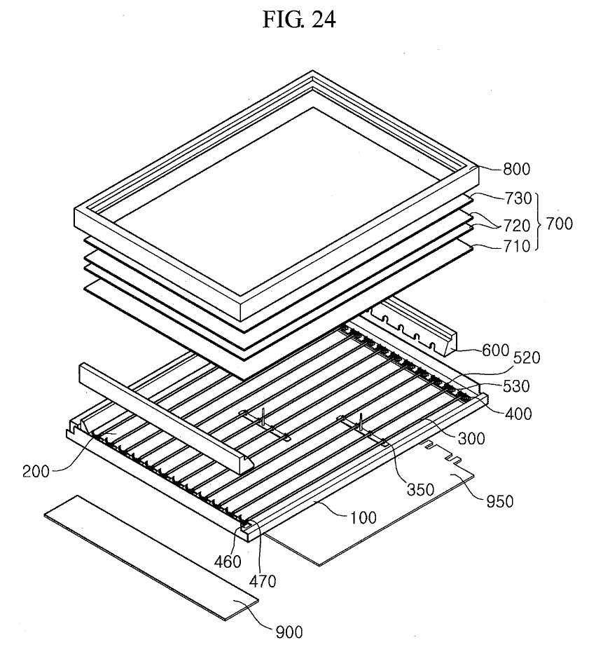

FIGS. 23A to 23E show connected structure of a lamp and the second lamp socket.

Referring to FIGS. 23A to 23E, a lamp lead 320 is seated on the seating face 513 of the second lamp lead seating portion, and the contact portion 517 of the second lamp lead seating portion get in contacts with the circuit board 960 equipped with the inverter (not shown). As a result, power from the inverter is applied to the lamp lead 320 through the circuit board 960, the contact portion 517 of the second lamp lead seating portion, the fourth body 511, and the seating face 513.

FIG. 24 is an exploded perspective view of a backlight assembly equipped with first lamp sockets and second lamp sockets according to a ninth embodiment of the invention.

Referring to FIG. 24, a backlight assembly includes a chassis 100, a reflective plate 200, lamps 300, lamp supporters 350, lamp sockets 400, side mold frames 600, optical sheets 700, a mold frame 800, a light-shield member 900, and an inverter unit 950.

The chassis 100 is provided with a receiving space defined by an receiving face and sidewalls. The reflective plate 200 is disposed on the receiving face of the chassis 100 to reflect light emitted from the lamps 300 towards a liquid crystal display panel (not shown).

The first lamp sockets 401 are arranged at one side on the receiving face of the chassis 100 and the second lamp sockets 500 are arranged at the other side. The lamps 300 are fixed by the first and second lamp sockets and supplied with power, and the lamp supporters 350 are disposed under intermediate portion of the lamps 300 to support them. As described above, the first lamp sockets 401 fix the ground lamp leads and form ground structures and the second lamp sockets fix the hot lamp leads.

The side mold frame 600 is fastened to the left and right sidewalls of the chassis 100. The optical sheets 700, such as a diffusion plate 710, a prism sheet 720, and a protective sheet 730 are sequentially stacked on the side mold frames 600. The side mold frames 600 are disposed on the first lamp sockets 401 and the second lamp sockets 500.

Since parts of the chassis 100 are cut and bent to be used as parts of the first lamp sockets 401, through-holes 150 with a predetermined shape are formed in the chassis 100. To block light emitted from the lamps 300 past the through-holes 150, the light-shield member 900 is provided on the chassis 100. A black tape may be attached as the light-shield member 900 on the receiving face of the chassis or on the opposite face.

A liquid crystal display may be achieved by arranging a liquid crystal display panel that displays images, on the backlight assembly according to the above embodiment of the invention.

Although the preferred embodiments of the present invention have been disclosed for illustrative purposes, by way of examples for lamp sockets, a backlight assembly equipped with the lamp sockets, and a liquid crystal display equipped with the backlight assembly of the invention, the present invention is not limited thereto, and those skilled in the art will appreciate that various modifications, additions and substitutions are possible, without departing from the scope and spirit of the invention as disclosed in the accompanying claims.

According to the embodiments of the invention, it is possible to simplify a structure of a lamp socket and reduce materials cost by forming the lamp socket of a part of a chassis.

Further, since the number of components is reduced, it is possible to save manufacturing time and the cost accordingly.

What is claimed is:

1. A lamp socket comprising:
a lamp lead seating portion to seat a lamp lead;
a contact terminal connectable to the lamp lead seating portion for fixing the lamp lead seated in the lamp lead seating portion.

2. The lamp socket of claim 1, wherein the lamp lead seating portion includes a blade and a seating groove formed in the blade, and the contact terminal includes a spring tab placed on the lamp lead seating portion and a gantry extending from the spring tab to press the lamp lead.

3. The lamp socket of claim 2, further comprising:
a housing which includes a body provided with a receiving space covering the lamp lead seating portion and the contact terminal.

4. The lamp socket of claim 3, further comprising:
a first fastening portion for fastening the lamp lead seating portion to the housing.

5. The lamp socket of claim 4, further comprising:
a second fastening portion for fastening the contact terminal to the housing.

6. The lamp socket of claim 2, further comprising:
a third fastening portion for fastening the contact terminal to the lamp lead seating portion.

7. The lamp socket of claim 2, wherein the blade of the lamp lead seating portion is formed in a plate shape and the seating groove extends from a sidewall of the blade in a first direction.

8. The lamp socket of claim 2, wherein the gantry of the contact terminal is formed by extending from a side of the spring tab, at a position corresponding to the seating groove.

9. A backlight assembly comprising:
a chassis provided with a receiving space;
lamps each of which includes of a lamp tube and lamp leads provided at both ends of the lamp tube; and
lamp sockets disposed inside the chassis to fix and apply power to the lamps, wherein the lamp socket includes a lamp lead seating portion to seat the lamp lead thereon, and the lamp lead seating portion is formed of a part of the chassis.

10. The backlight assembly of claim 9, wherein the lamp lead seating portion has a blade and a seating groove formed on the blade.

11. The backlight assembly of claim 10, wherein the lamp socket further includes a contact terminal fastened to the lamp lead seating portion for fixing the lamp lead seating portioned on the lamp lead seating portion.

12. The backlight assembly of claim 11, wherein the contact terminal includes a spring tab placed on the lamp lead seating portion and a gantry extending from the spring tab and pressing the lamp lead.

13. The backlight assembly of claim 10, wherein the blade of the lamp lead seating portion is formed by cutting a part of the chassis and bending the cut portion perpendicularly to an receiving face of the chassis.

14. The backlight assembly of claim 13, further comprising:
a light-shield member for covering through-holes formed in the chassis.

15. The backlight assembly of claim 9, wherein the lamp leads are a first lamp lead for applying power and a second lamp lead for grounding, and the lamp socket fixes the second lamp lead for grounding.

16. The backlight assembly of claim 10, wherein the lamp lead is fixed in the seating groove of the lamp lead seating portion by forced-fitting or soldering.

17. A liquid crystal display comprising:
a backlight assembly including a chassis provided with a receiving space, lamps each including a lamp tube and a lamp lead provided at both ends of the lamp tube, and lamp sockets disposed inside the chassis to fix and apply power to the lamps; and
a liquid crystal display panel disposed on the backlight assembly to display images,
wherein the lamp socket includes a lamp lead seating portion to seat the lamp lead thereon and the lamp lead seating portion is formed of a part of the chassis.

18. A backlight assembly comprising:
a chassis provided with a receiving space;
side mold frames fastened to the chassis;
lamps including a lamp tube and lamp leads provided at both ends of the lamp tube; and
first lamp sockets disposed inside the chassis to fix and apply power to the lamps,
wherein the first lamp socket includes; a first lamp lead seating portion having a blade, and a seating face extended from the blade, in order to seat the lamp lead; and
a first contact terminal disposed on the first lamp lead seating portion to fix the lamp lead seating portioned on the first lamp lead seating portion, and the blade of the first lamp lead seating portion is formed of a part of the chassis.

19. The backlight assembly of claim 18, further comprising:
a first fastening portion for fastening the first contact terminal to the side mold frame.

20. The backlight assembly of claim 18, wherein the blade of the first lamp lead seating portion is formed in a plate shape and the seating face is recessed from the blade with a curved surface.

21. The backlight assembly of claim 20, wherein the blade of the first lamp lead seating portion is formed by cutting a part of the chassis and bending the cut portion perpendicularly to an receiving face of the chassis.

22. A backlight assembly comprising:
a chassis provided with a receiving space;
side mold frames fastened to the chassis;
lamps each including a lamp tube and a lamp lead provided at both ends of the lamp tube;
second lamp sockets disposed inside the chassis to fix and apply power to the lamps; and
an inverter unit including an inverter for supplying power to the lamps and a circuit board equipped with the inverter,
wherein the second lamp socket includes:
a second lamp lead seating portion having a fourth body, a seating face extended from the fourth body, and a contact portion extended from the fourth body to be in contact with the circuit board of the inverter unit, in order to seat the lamp lead;
a second contact terminal having a fifth body placed on the second lamp lead seating portion to fix the lamp lead which is seated on the second lamp lead seating portion; and
a guide having a sixth body and an accommodating portion formed on the sixth body to accommodate the second lamp lead seating portion, in order to fix the second lamp lead seating portion.

23. The backlight assembly of claim 22, further comprising:
a second fastening portion for fastening the second lamp lead seating portion to the guide.

24. The backlight assembly of claim 22, further comprising:
a third fastening portion for fastening the second contact terminal to the side mold frame.

25. The backlight assembly of claim 22, further comprising:
a fourth fastening portion for fastening the guide to the chassis.
